(19) United States
(12) Patent Application Publication
(10) Pub. No.: US 2011/0000344 A1
(43) Pub. Date: Jan. 6, 2011

(54) DEPTH GAUGE AND ADJUSTMENT TOOL FOR ADJUSTABLE FASTENER RECEPTACLES AND METHOD

(76) Inventor: Jeremy Summers, Sorrento, FL (US)

Correspondence Address: EDWARD M. LIVINGSTON, PA, 963 TRAIL TERRACE DRIVE, NAPLES, FL, 34103, US

(21) Appl. No.: 12/495,983

(22) Filed: Jul. 1, 2009

(51) Int. Cl. B25B 23/00; G01B 5/18

(52) U.S. Cl. 81/429; 33/567.1

(57) ABSTRACT

A depth gauge and adjustment tool (1) having a handle (2) having a shaft (3) extending from one end of the handle. A tip (4) having a cross pin (5) attached thereto extends from the shaft. A sleeve (9) fits over the cap (6), shaft and handle and slides back an forth along the cap, shaft and handle while the depth gauge and adjustment tool 1 is in use. The sleeve houses a sleeve spring (10), which provides resistance between the sleeve and the handle. A lip (11) on the inner surface (12) of the sleeve pushes against one end of the sleeve spring and prevents the sleeve from sliding past a predetermined point on the handle. Measurement markings (13) located on the handle are used in conjunction with the sliding sleeve to measure the depth of an adjustable fastener receptacle (21).

### BACKGROUND OF THE INVENTION

This invention relates to adjustable fastener receptacles, more particularly, a depth gauge and adjustment tool that allows a user to set an adjustable fastener receptacle to a required depth and measure the depth of the adjustable fastener receptacle to determine the required fastener stud length without the need to dry fit the materials being fastened together.

Currently, adjustable fastener receptacles are used in conjunction with fastener studs in the construction of airplanes and other products that have panels, such as automobiles, boats, enclosures, cabinets, etc., to install and secure panels to the body of the airplane or other structure. A problem with the use of adjustable depth receptacles is that a panel must first be installed on the airplane and then the fastener stud has to be engaged into the adjustable depth receptacle to determine the depth the adjustable fastener receptacle needs to be set to in order to accommodate the thickness of the panel being fastened to the airplane or other structure. Once the proper depth is measured, the panel must then be removed from the body of the airplane so that the appropriate depth can be set and locked into the adjustable fastener receptacle. Finally, the panel must be reinstalled and secured to the body of the airplane using the adjustable fastener receptacle. This process of dry fitting the panel on the body of the airplane is labor intensive and time consuming.

Therefore, a need exists for a device that can be used to adjust the depth of an adjustable fastener receptacle while the adjustable fastener receptacle is engaged in a panel and a device that can measure the depth of the adjustable fastener receptacle to determine the appropriate fastener stud length.

The relevant prior art includes the following references:

| Pat. No. | | |
|---|---|---|
| (U.S. unless | | |
| stated otherwise) | Inventor | Issue/Publication/Date |
| 7,210,382 | McCracken | May 01, 2007 |
| 2007/0034060 | McCracken | Feb. 15, 2007 |
| DE202006009348 | Brinkman | Oct. 26, 2006 |
| 2006/0236815 | Beecherl | Oct. 26, 2006 |
| 7,055,729 | Taylor et al. | Jun. 06, 2006 |
| 2006/0065692 | Taylor et al. | Mar. 30, 2006 |
| 5,524,512 | Wolfe | Jun. 11, 1996 |
| 5,385,286 | Johnson, Jr. | Jan. 31, 1995 |
| 5,341,704 | Klemm | Aug. 30, 1994 |
| DE404504 | Fuerbass | Jul. 04, 1991 |
| 5,013,318 | Spranza, III | May 07, 1991 |
| 4,637,539 | Turcott et al. | Jan. 20, 1987 |

### SUMMARY OF THE INVENTION

The primary object of the present invention is to provide a depth gauge and adjustment tool for adjustable fastener receptacles that allows a user to adjust the depth of an adjustable fastener receptacle while the adjustable fastener receptacle is engaged in a panel.

A further object of the present invention is to provide a depth gauge and adjustment tool for adjustable fastener receptacles that allows a user to measure the depth of an adjustable fastener receptacle while the adjustable fastener receptacle is engaged in a panel.

An additional object of the present invention is to provide a depth gauge and adjustment tool for adjustable fastener receptacles that assists a user in determining the proper fastener stud length to use with an adjustable fastener receptacle.

A further object of the present invention is to provide a depth gauge and adjustment tool for adjustable fastener receptacles that reduces the time it takes to install a panel using adjustable fastener receptacles.

The present invention fulfills the above and other objects by providing a depth gauge and adjustment tool having for adjustable fastener receptacles a handle with a shaft extending from one end of the handle. A tip having a cross pin attached thereto extends from the shaft. A cap having a cap hole fits over the tip and slides back an forth along the tip in-between the shaft and the cross pin. The cap houses a spring, which provides resistance between the cap and the shaft. A sleeve fits over the cap, shaft and handle and slides back an forth along the cap, shaft and handle while the depth gauge and adjustment tool is in uses. The sleeve houses a spring, which provides resistance between the sleeve and the handle. A lip on the inner surface of the sleeve pushes against one end of the sleeve spring and prevents the sleeve from sliding past a predetermined point on the handle.

The tool is used to adjust an adjustable fastener receptacle to a required depth in order to accommodate the thickness of whatever material that is being fastened together. In addition, the depth gauge and adjustment tool may also be used to measure the depth of an adjustable fastener receptacle in order to assist a user in selecting the proper fastener stud length to use with the adjustable fastener receptacle.

To use, the depth gauge and adjustment tool is inserted into an adjustable fastener receptacle and turned so that the cross pin engages the receptacle the same way a fastener would. Then the shaft is turned clockwise or counterclockwise to adjust the receptacle to the appropriate depth depending on the thickness of the materials being secured together. Next, the user measures the depth of the adjustable depth receptacle from the side of the depth gauge in order to determine the required fastener stud length. Then, the depth gauge and adjustment tool is disengaged from the adjustable fastener receptacle by pushing the tip into the adjustable fastener receptacle and turning the depth gauge and adjustment tool counterclockwise until the cross pin disengages from the adjustable fastener receptacle. Finally, the depth gauge and adjustment tool is removed from adjustable fastener receptacle.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is an exploded cross-sectional side view of a depth gauge and adjustment tool of the present invention;

FIG. 2 is a cross sectional side view of a depth gauge and adjustment tool of the present invention;

FIG. 3 is a front view of a fastener stud;

FIG. 4 is a front view of an adjustable fastener receptacle into which the tool of the present invention is used to adjust and measure;

FIG. 5 is a front perspective cross-sectional view of a fastener stud engaged in an adjustable fastener receptacle and a panel; and

FIG. 6 is a flow chart showing a method for measuring and adjusting the depth of an adjustable fastener receptacle using the depth gauge and adjustment tool of the present invention.

### DESCRIPTION OF THE PREFERRED EMBODIMENTS

For purposes of describing the preferred embodiment, the terminology used in reference to the numbered accessories in the drawings is as follows:
1. tool
2. handle
3. shaft
4. tip
5. cross pin
6. cap
7. cap hole
8. cap spring
9. sleeve
10. spring sleeve
11. lip
12. inner surface
13. measurement markings
14. insert tip
15. engage cross pin
16. adjust depth
17. measure depth
18. disengage cross pin
19. remove tip
20. fastener stud
21. adjustable fastener receptacle
22. panel

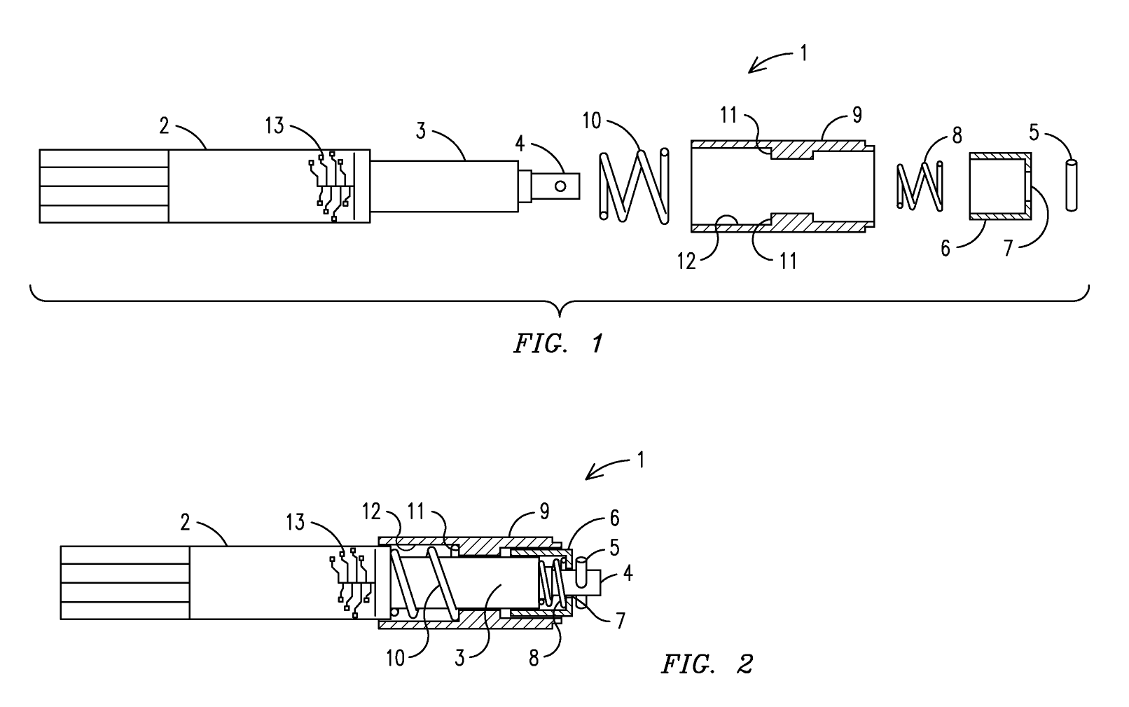

With reference to FIG. 1, an exploded cross-sectional side view of a depth gauge and adjustment tool 1 of the present invention is shown. The depth gauge and adjustment tool 1 comprises a handle 2 having a shaft 3 extending from one end of the handle 2. A tip 4 having a cross pin 5 attached thereto extends from the shaft 3. A cap 6 having a cap hole 7 fits over the tip 4 and slides back and forth along the tip 4 in-between the shaft 3 and the cross pin 5. The cap 6 houses a cap spring 8, which provides resistance between the cap 6 and the shaft 3. A sleeve 9 fits over the cap 6, shaft 3 and handle 2 and slides back an forth along the cap 6, shaft 3 and handle 2 while the depth gauge and adjustment tool 1 is in use. The sleeve 9 houses a sleeve spring 10, which provides resistance between the sleeve 9 and the handle 2. A lip 11 on the inner surface 12 of the sleeve 9 pushes against one end of the sleeve spring 10 and prevents the sleeve 9 from sliding past a predetermined point on the handle 2. Measurement markings 13 located on the handle 2 are used in conjunction with the sliding sleeve 9 to measure the depth of an adjustable fastener receptacle 21, which is shown in FIG. 4.

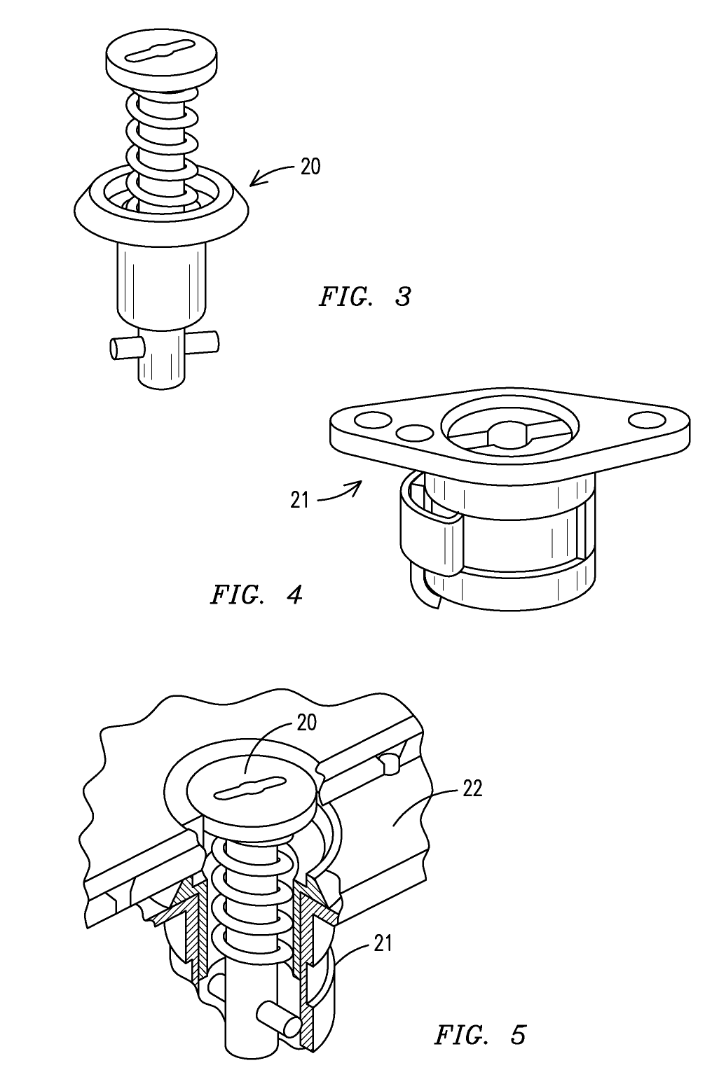

Referring now to FIG. 2, a cross sectional side view of a depth gauge and adjustment tool of the present invention is shown. The depth gauge and adjustment tool 1 comprises a handle 2 having a shaft 3 extending from one end of the handle 2. A tip 4 having a cross pin 5 extends from the shaft 3. A cap 6 having a cap hole 7 fits over the tip 4 and slides back and forth along the tip 4 in-between the shaft 3 and the cross pin 5. The cap 6 houses a cap spring 8, which provides resistance between the cap 6 and the shaft 3. A sleeve 9 fits over the cap 6, shaft 3 and handle 2 and slides back an forth along the cap 6, shaft 3 and handle 2 while the depth gauge and adjustment tool 1 is in use. The sleeve 9 houses a sleeve spring 10, which provides resistance between the sleeve 9 and the handle 2. A lip 11 on the inner surface 12 of the sleeve 9 pushes against one end of the sleeve spring 10 and prevents the sleeve 9 from sliding past a predetermined point on the handle 2. The depth gauge and adjustment tool 1 for adjustable fastener receptacles may be used to adjust an adjustable fastener receptacle to a required depth in order to accommodate the thickness of material being fastened together, as shown in FIG. 3. Measurement markings 13 located on the handle 2 are used in conjunction with the sliding sleeve 9 to measure the depth of an adjustable fastener receptacle 21 after the adjustable fastener receptacle 21 has been set to the required depth in order to assist a user in selecting a proper fastener stud 20, as illustrated in FIG. 3 below, length to use with an adjustable fastener receptacle 21, as illustrated in FIG. 4 below.

Referring now to FIG. 3, a front view of a fastener stud 20 is shown. The purpose of the tool 1 of the present invention is to measure the depth of the adjustable fastener receptacle 21 to determine the correct size of the fastener stud 20 to be fastened into the adjustable fastener receptacle 21

Referring now to FIG. 4, a front view of an adjustable fastener receptacle 21 into which the tool 1 of the present invention is used to adjust and measure is shown.

Referring now to FIG. 5, a front perspective cross-sectional view of a fastener stud 20 engaged in an adjustable fastener receptacle 21 and a panel 22 is shown.

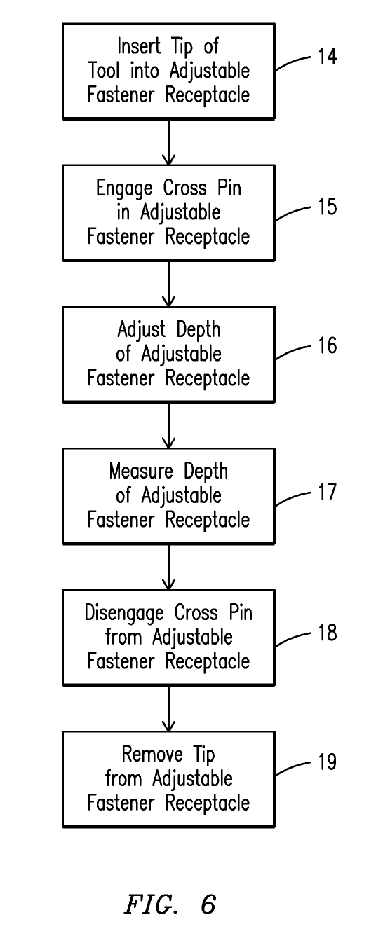

Finally referring to FIG. 6, a flow chart showing a method for measuring and adjusting the depth of an adjustable fastener receptacle using the depth gauge and adjustment tool 1 of the present invention is shown. First, the tip 4 of the depth gauge and adjustment tool 1 is inserted into an adjustable fastener receptacle 21, 14. Next, the depth gauge and adjustment tool 1 is turned clockwise until the cross pin 5 engages the adjustable fastener receptacle 21, thereby locking the tip 4 of the depth gauge and adjustment tool 1 into the adjustable fastener receptacle 15. Then, the depth gauge and adjustment tool 1 is turned clockwise or counterclockwise in order to adjust the adjustable fastener receptacle 21 to the appropriate depth to accommodate the thickness of the materials being fastened together 16. Next, the depth of the adjustable fastener receptacle 21 is measured in order to determine the required fastener stud 20 length using the measurement markings 13 on the side of the depth gauge and adjustment tool 1, 17. Then, the depth gauge and adjustment tool 1 is disengaged from the adjustable fastener receptacle 21 by pushing the tip 4 into the adjustable fastener receptacle 21 and turning the depth gauge and adjustment tool 1 counterclockwise until the cross pin 5 disengages from the adjustable fastener receptacle 21, 18. Finally, the tip 4 of the depth gauge and adjustment tool 1 is removed from the adjustable fastener receptacle 19.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

Having thus described my invention, I claim:

1. A depth gauge and adjustment tool for adjustable fastener receptacles comprising:
a handle;
a shaft extending from one end of the handle;
tip extending from the one end of the shaft; and
a cross pin attached to the tip for engaging an adjustable fastener receptacle.

2. The depth gauge and adjustment tool for adjustable fastener receptacles of claim 1 further comprising:
a cap having a cap hole that fits over the tip and slides back an forth along the tip in-between the shaft and the cross pin while the depth gauge and adjustment tool is in use;
and a cap spring that provides resistance between the cap and the shaft while the cap slides back and forth.

3. The depth gauge and adjustment tool for adjustable fastener receptacles of claim 1 further comprising:
a sleeve that fits over the shaft and handle and slides back an forth along the shaft and handle while the depth gauge and adjustment tool is in use; and
a sleeve spring that provides resistance between the sleeve and the handle while the sleeve slides back and forth.

4. The depth gauge and adjustment tool for adjustable fastener receptacles of claim 2 further comprising:
a sleeve that fits over the cap, shaft and handle and slides back an forth along the cap, shaft and handle while the depth gauge and adjustment tool is in use; and
a sleeve spring that provides resistance between the sleeve and the handle while the sleeve slides back and forth.

5. The depth gauge and adjustment tool for adjustable fastener receptacles of claim 3 further comprising:
a lip on the inner surface of the sleeve that pushes against one end of the sleeve spring and prevents the sleeve from sliding past a predetermined point on the handle.

6. The depth gauge and adjustment tool for adjustable fastener receptacles of claim 4 further comprising:
a lip on the inner surface of the sleeve that pushes against one end of the sleeve spring and prevents the sleeve from sliding past a predetermined point on the handle.

7. The depth gauge and adjustment tool for adjustable fastener receptacles of claim 3 further comprising:
at least one measurement marking on the handle for measuring the depth of an adjustable fastener receptacle.

8. The depth gauge and adjustment tool for adjustable fastener receptacles of claim 4 further comprising:
at least one measurement marking on the handle for measuring the depth of an adjustable fastener receptacle.

9. A depth gauge and adjustment tool for adjustable fastener receptacles comprising:
a handle;
a shaft extending from one end of the handle;
tip extending from the one end of the shaft; and
a cross pin attached to the tip for engaging an adjustable fastener receptacle;
a cap having a cap hole that fits over the tip and slides back an forth along the tip in-between the shaft and the cross pin while the depth gauge and adjustment tool is in use; and
a cap spring that provides resistance between the cap and the shaft while the cap slides back and forth.

10. The depth gauge and adjustment tool for adjustable fastener receptacles of claim 9 further comprising:
a sleeve that fits over the cap, shaft and handle and slides back an forth along the cap, shaft and handle while the depth gauge and adjustment tool is in use; and
a sleeve spring that provides resistance between the sleeve and the handle while the sleeve slides back and forth.

11. The depth gauge and adjustment tool for adjustable fastener receptacles of claim 10 further comprising:
a lip on the inner surface of the sleeve that pushes against one end of the sleeve spring and prevents the sleeve from sliding past a predetermined point on the handle.

12. The depth gauge and adjustment tool for adjustable fastener receptacles of claim 3 further comprising:
at least one measurement marking on the handle for measuring the depth of an adjustable fastener receptacle.

13. A method for measuring and adjusting the depth of an adjustable fastener receptacle using a depth gauge and adjustment tool comprising a handle, a shaft extending from one end of the handle, a tip extending from the one end of the shaft, a cross pin attached to the tip for engaging an adjustable fastener receptacles, a cap having a cap hole that fits over the tip and slides back an forth along the tip in-between the shaft and the cross pin, a cap spring that provides resistance between the cap and the shaft while the cap slides back and forth, a sleeve that fits over the cap, shaft and handle and slides back an forth along the cap, shaft and handle while the depth gauge and adjustment tool is in use, a sleeve spring that provides resistance between the sleeve and the handle while the sleeve slides back and forth and at least one measurement marking on the handle for measuring the depth of an adjustable fastener receptacle, said method comprising the steps of:
a. inserting the tip of the depth gauge and adjustment tool into an adjustable fastener receptacle;
b. turning the depth gauge and adjustment tool clockwise until the cross pin engages the adjustable fastener receptacle, thereby locking the tip of the depth gauge and adjustment tool into the adjustable fastener receptacle;
c. turning the depth gauge and adjustment tool clockwise or counterclockwise to adjust the adjustable fastener receptacle to the appropriate depth to accommodate the thickness whatever materials are being fastened together; and
d. disengaging the depth gauge and adjustment tool from the adjustable fastener receptacle by pushing the tip into the adjustable fastener receptacle and turning the depth gauge and adjustment tool counterclockwise until the cross pin disengages from the adjustable fastener receptacle.

14. The method of claim 13 further comprising a step after step c of:
using the measurement markings on the side of the depth gauge and adjustment tool to measure the depth of the adjustable fastener receptacle in order to determine a required fastener stud length.

15. The method of claim 13 further comprising a step after step d of:
removing the depth gauge and adjustment tool from the adjustable fastener receptacle.
